(19) United States
(12) Patent Application Publication
(10) Pub. No.: US 2024/0070465 A1
(43) Pub. Date: Feb. 29, 2024

(54) AUTOMATED DATA PREPARATION SYSTEMS AND/OR METHODS FOR MACHINE LEARNING PIPELINES

(71) Applicant: Software AG, Darmstadt (DE)

(72) Inventor: Mohamed Osman Mohamed ABDELAAL, Stuttgart (DE)

(21) Appl. No.: 17/899,327

(22) Filed: Aug. 30, 2022

(51) Int. Cl. G06N 3/08; G06N 3/04

(52) U.S. Cl. CPC G06N 3/088; G06N 3/0454; G06N 3/0472

(57) ABSTRACT

Certain example embodiments relate to automated data preparation techniques usable to improve machine learning (ML) pipelines. Different error detectors are executed on a dirty dataset to identify which records therein include errors. Each record that has been identified by at least a threshold number of the error detectors as including an error is marked as erroneous. The dirty dataset's records are divided into clean and dirty fractions. If a data exclusion error has emerged, the process is repeated. Otherwise, a new set of data samples is generated by applying a variational autoencoder (VAE) to the clean fraction, the dirty dataset is augmented with the new set of data samples, and the augmented dirty dataset is provided for training of the ML model. It thus becomes possible to better training an ML model without having to repair data determined to include errors.

### TECHNICAL FIELD

Certain example embodiments described herein relate to improvements to machine learning (ML) technology and improvements to computer-based tools that leverage ML technology. More particularly, certain example embodiments described herein relate to automated data preparation systems and/or methods that may be used to improve machine learning pipelines.

### BACKGROUND AND SUMMARY

Recently, machine learning (ML) technology has been applied to a wide variety of application domains such as, for example, automotive, medical, pharmaceutical, and other domains. ML technology has had a large impact on these domains. For example, in these areas, ML technology has enabled self-driving cars, novel diagnostics, personalized treatment, and other advancements.

In such domains, and in enabling the above-noted and other advancements, ML technology typically involves the collection of different data modalities, including relational records, sensory readings, digital images and videos, audio, and text. Relational data refers to data stored in a table or a set of tables (or equivalent computer-mediated data structures), where the data is organized in the form of rows (also sometimes referred to as records) and columns (also sometimes referred to as attributes). Examples of relational data include sensory readings, medical reports, and financial records. The collected data is usually consumed by analytics tool and platforms to draw interesting conclusions and to make informed decisions. For example, the gathered data can lead to decisions on when to have an automobile speed up or slow down to avoid a collision, when to flag a shadow as a potential tumor, when to suggest a particular course of treatment with a low likelihood of adverse interactions, etc.

It will be appreciated that the value of such decisions and conclusions is highly dependent on the quality of the processed data. In other words, the performance of such analytics tools and platforms may strongly degrade when the collected data is noisy or contains errors.

Unfortunately, real-world data suffers from several error types, e.g., because of improper join operations, noisy communication channels, inaccurate and/or incomplete manual data entry, etc. Such problems may lead to different error types, including outliers, pattern violations, constraint/rules violations, duplicates, typos, inconsistencies, formatting issues, mislabeling, implicit/explicit missing values, and the like. Moreover, these distinct error types may exist simultaneously in a given dataset. In this regard, many datasets have a heterogeneity of error types.

Because high data quality helps boost the performance of ML models, the collected data typically is cleaned or curated, and prepared before being employed for modeling tasks. Data cleaning refers to the process of detecting and repairing erroneous samples in a dataset. It is also sometimes referred to as data cleansing or data curation. Data preparation refers to the preprocessing of datasets before being used as inputs to predictive models. Data preparation, broadly speaking, may include processes such as, for example, data annotation, data cleaning, data transformations, feature extractions, and/or the like.

A recent survey found that data scientists spend about 60% of their time cleaning and organizing data, and 57% of data scientists reported that this was the least enjoyable part of data science. Nonetheless, these tasks are critical to achieving good results. A report from IBM estimated that poor data quality costs the U.S. economy over $3 trillion per year.

FIG. 1 is a diagram showing a part of the ML preparation pipeline, where an error detection tool 104 is used to identify errors in a noisy or dirty dataset 102. A noisy or dirty dataset 102 includes dirty data, which may be thought of as including low-quality data samples that contain one or more error types. Error detection typically involves traversing the entire dataset to search for erroneous data samples. Error detection can be a one-shot process, or it can be performed iteratively. Errors are curated with the help of a data repair technique 106. The dashed line indicates that other preprocessing tasks, such as wrangling (which refers generally to a variety of processes designed to transform raw data into more readily used formats) and transformations, may be carried out to bring the data into a state suitable for ML modeling and serving 108. Ultimately, clean data is generated. Clean data is contrastable with noisy or dirty data, in that it may be thought of as including high-quality data samples collected without error profiles. These samples achieve a set of application-relevant quality metric such as completeness, accuracy, timeliness, uniqueness, and consistency.

Data repair ideally involves replacing erroneous data samples with generated values close to “ground truth.” Doing so helps promote the predictive performance of the ML model being trained/used. There are two main approaches, namely, detecting different errors with high precision and recall, and generating accurate repair values for the detected errors. When thinking about a taxonomy of data cleaning approaches, there are quantitative, qualitative, and holistic cleaning techniques. Qualitative cleaning techniques include rule-based approaches, pattern enforcement and transformation tools, etc. Quantitative cleansing techniques typically make use of statistical approaches. Holistic cleaning techniques can involve probabilistic and ML-based approaches, as well as ensemble approaches (e.g., implementing voting-based and sequential methods).

Instead of replacing the erroneous samples, some strategies opt for omitting them, such as the case with duplicates cleaners and some outlier repair methods. In fact, there are a number of tools and techniques for error detection and repair. Yet such tools usually suffer from several disadvantages. For instance, it is usually challenging to remove some error types, such as rule violations or pattern violations, as data repair typically requires domain knowledge and skilled individuals who can formulate such knowledge as a set of rules/constraints. Moreover, ML-based error detection approaches cannot always reliably recognize error types. Accordingly, data repair becomes a challenging task, given that there is a potentially huge search space for possible repair candidates.

Recently, some tools have been developed for automated rule generation. In this case, the generated rules can be used to detect rule violations, either directly or after some transformations. But there are still data repair challenges, particularly when several repair approaches have to be adopted to generate a set of repair candidates. Indeed, in some instances, it can be challenging to determine the best repair candidates in the first place. As an example, FIG. 2 illustrates a record 200 with a plurality of cells c₁-c₁₀ and one cell cm with a missing value, i.e., an empty cell. In some cases, an entire record will be removed if it has any missing values or empty cells. To avoid removing the record 200 in its entirety in such situations, the value for the empty cell cm has to be properly imputed. There are a variety of potential imputation methods, so it can be difficult to select a specific imputation method suitable for the application. Schematically, FIG. 2 shows that three repair candidates (i.e., a₁, a₂, and a₃) have been generated as a result of using three distinct imputation methods. From a broader pipeline perspective, FIG. 3 is a modified version of the pipeline of FIG. 1, where several data repair techniques 106a-106n are involved in the preparation process.

As will be appreciated from the description above, there are a number of existing approaches to performing data cleaning via error detection and data repair modules. For instance, HoloClean is an ML-agnostic data repair technique that infers repair values via holistically employing multiple cleaning signals to build a probabilistic graph model. To repair pattern violations and inconsistencies, OpenRefine utilizes Google Refine Expression Language (GREL) as its native language to transform existing data or to create repair values. Similarly, BARAN is a holistic configuration-free ML-based method for repairing different error types. BARAN trains incrementally updatable models that leverage the value, vicinity, and domain contexts of data errors to propose correction candidates. To further increase the training data, BARAN exploits external sources, such as Wikipedia page revision history.

Existing tools like HoloClean, OpenRefine, and BARAN, do not consider requirements imposed by the downstream ML applications. They seek to improve the data quality, but there are challenges because these tools do not account for where the data comes from, how it was obtained, and how it will be consumed. A further set of techniques and tools has emerged as a result of this shortcoming. These techniques and tools strive to jointly optimize the cleaning and modeling tasks. In other words, these ML-oriented approaches focus on selecting the optimal repair candidates with the objective of improving the performance of specific predictive models. Accordingly, these approaches assume the availability of repair candidates from other ML-agnostic methods. For instance, BoostClean deals with the error repair task as a statistical boosting problem. It composes a set of weak learners into a strong learner. To generate the weak learners, BoostClean iteratively selects a pair of detection and repair methods, before applying them to the training set to derive a new model.

ActiveClean is another ML-oriented method principally employed for models with convex loss functions. It formulates the data cleaning task as a stochastic gradient descent problem. Initially, it trains a model on a dirty training set, where such a model is to be iteratively updated until reaching a global minimum. In each iteration, ActiveClean samples a set of records and then asks an oracle to clean them to shift the model along the steepest gradient. Similarly, CPClean incrementally cleans a training set until it is certain that no more repairs can possibly change the model predictions. And AlphaClean similarly transforms data cleaning into a hyperparameter optimization problem. AlphaClean composes several pipelined cleaning operations that need to be extracted from a predefined search space. In fact, these ML-oriented approaches to data repair do not introduce new data repair techniques, such as HoloClean and BARAN. Instead, they tend to select the already-existing repair candidates that may improve the predictive performance.t

WO 2022/059135 introduces a data preprocessing unit that generates training data that has an appropriate format for input to a machine learning model. The data preprocessing unit generates a learning model that detects an error for each of various types of errors that occurs without prior labeling of error factors. Another approach similarly introduces a method for error detection in Chinese text. This method relies on intelligent decision-making technologies, including artificial intelligence and blockchain technology. To improve the detection performance, the method trains multiple error detection models. This design respectively acquires multiple pieces of model detection information, where screening and results integration processes are carried out on the model detections to obtain the final text checking result. In still another example, a system that removes noise from data samples is introduced. For this purpose, the system implements a discriminator that makes determinations to classify input data samples. Although de-noising the datasets may be a reasonable solution to improve the data quality, it unfortunately may be not sufficient to improve the predictive performance. For example, removing the noisy samples without enhancing the number of clean samples may negatively impact the distribution of the data. And ML-oriented data cleaners disadvantageously involve increased computational complexity because several repair methods are run and an additional method is used to select the best repair candidates, and also tend to be tailored to specific ML models and tend to have problems with certain common scenarios.

It will be appreciated that, as explained above, conventional data cleaning techniques divide the curation process into different phases, including error detection and data repair. And in view of the foregoing, it will be appreciated that current error detection tools and techniques have shortcomings that hinder their wide-scale applicability to ML applications. For example, because of the potentially huge search space, conventional data repair approaches typically cannot restore the original and actual values of dirty samples. Moreover, several data repair techniques typically have to be involved given a lack of knowledge about the error type(s) in the detected dirty data samples. In such cases, a third phase is introduced into the curation process to select the repair candidates that might lead to a faster convergence of the downstream machine learning models.

Certain example embodiments help address the above-described and/or other concerns. For example, certain example embodiments help address data repair issues associated with ML applications to provide more accurate ML models and improved tools using such models.

Certain example embodiments relate to approaches to addressing data repair challenges that oftentimes arise in connection with ML applications. According to information theory (a branch of mathematics that defines efficient and practical approaches by which data can be exchanged and interpreted), reducing the noise in a dataset can be equivalent to adding more data with similar quality. Certain example embodiments are pillared on such a theory and partially or completely avoid a defined data repair procedure. More specifically, certain example embodiments replace conventional data repair with data augmentation to increase the proportion of clean data for the sake of reducing the impact of noisy records. Data augmentation in the context of the instant application refers generally to the process of increasing the amount of data by adding slightly modified copies of already-existing data or newly-created synthetic data from existing data.

FIGS. 4A-4C are graphs that help to illustrate the approach underlying certain example embodiments. FIG. 4A shows a small dataset that includes a set of clean samples (lighter circles), and a set of noisy data samples (darker circles). In FIG. 4A, the two curves represent ML models that can be generated using this noisy data. To improve the predictive performance, an ML model can be trained to help accurately fit the clean data samples. To this end, the noisy data samples can be repaired using a data repair method, as in FIG. 4B. FIG. 4B is a graph showing a small dataset with clean labels. In FIG. 4B, there are no noisy data samples that need to be converted to clean values. In this case, the curve represents the best model that can be used to generate accurate predictions. However, conventional data repair methods cannot restore the true values of the noisy samples. Moreover, the repair process is usually complex. In this sense, FIG. 4B really is an idealized and not always achievable representation. Therefore, an alternative strategy for dealing with the problem is to increase the number of clean samples, as shown in FIG. 4C. In this case, the impact of the dirty samples on the ML modeling process will be greatly reduced. As a result, the generated ML model (represented by the curve in FIG. 4C) will resemble the curve shown in FIG. 4B.

The techniques of different example embodiments can be used in multiple applications where structured data is collected, curated, and analyzed, e.g., to extract useful insights and to make informed decisions. For instance, in a smart factory use case (including the dataset available from kaggle), various machines may be equipped with a set of sensors that frequently generate measurements to predict maintenance operations. In this scenario, there are several sources of data errors such as, for example, missing values caused by sensor malfunctions or communication problems, outliers caused by data fusion or seasonal changes, etc. In an automotive context, sources of data errors or violations of rules/constrains can relate to outliers caused by weather variations (e.g., an abnormally warm day during the winter), an unpredictable reckless driver, an unannounced road closure due to an accident, etc. In the pharmaceutical context, missing values may relate to unknown medications a person is taking, duplicate values may be caused by name-brand and generics being provided to a patient at different times, etc. Certain example embodiment in these situations advantageously can (1) generate a complete and clean set of data, (2) reduce the impact of anomalous data samples, and (3) enable improved training and inference of ML models, e.g., to produce better recommendations, reports, and/or the like. For instance, better recommendations may be provided regarding when to perform maintenance on machinery, how to navigate a road hazard, what medicine to prescribe, etc.

The improvements are technical because they improve the data going into the model, the model itself, and the computer-implemented tools implementing the models. This is because the effective transformation of the data by virtue of the data augmentation improves the data quality, which improves the model in turn improving the tool, including its accuracy and predictive power.

Rather than having to select the already-existing repair candidates that may improve the predictive performance of the ML model, certain example embodiments avoid having to generate repair candidates. Accordingly, certain example embodiments advantageously can avoid the complexities of searching for the repair candidates and selecting the best subset from those candidates. Furthermore, ML-oriented approaches typically are tailored to specific optimization methods and ML models, e.g., ActiveClean is limited to problems with convex loss functions. Certain example embodiments are not so limited. In other words, certain example embodiments propose an approach that is not specific for a given class of ML models or errors.

One aspect of certain example embodiments relates to implementing an adaptive ensemble-based error detection approach that helps address issues with false positive error detection at the class and/or attribute level. For example, certain example embodiments help capture most or all errors in a dataset while preserving the balance between different classes in the data (e.g., avoiding the elimination of all records that have a certain value).

Another aspect of certain example embodiments is that the approach does not necessarily require the recognition of error types because noisy data samples instead can be ignored. Rather, certain example embodiments generally operate using clean samples, which can lead to better modeling performance, e.g., if more clean samples already exist.

Another aspect of certain example embodiments relates to the ability to avoid complicated approaches for searching the potentially huge space of repair candidates, and the process of selecting the most suitable possible repair candidates.

Still another aspect of certain example embodiments involves data augmentation, which not only reduces the impact of noisy data samples, but also improves the predictive performance and helps guard against overfitting (which occurs when a model fits exactly against its training data, meaning that the model accurately perform against unseen data given the lack of sufficient generalization).

Certain example embodiments involve the adaptation of an ensemble approach to help avoid problems in the datasets related to poor detection performance by individual error detection methods.

In certain example embodiments, a system for training a machine learning (ML) model is provided. The system includes at least one preprogrammed error detector, as well as at least one processor and a memory coupled thereto. The at least one processor is configured to perform operations comprising: (a) executing the at least one error detector on a dirty dataset to identify which records of the dirty dataset include errors; (b) marking as erroneous each record that has been identified as including an error, based on a comparison to a threshold value; (c) dividing the records from the dirty dataset into a clean fraction and a dirty fraction, the dirty fraction including the record(s) marked as erroneous, the clean fraction including the record(s) not marked as erroneous; (d) detecting whether a data exclusion error emerges in the dividing of the records into the clean fraction and the dirty fraction; and (e) in response to a detection that a data exclusion error has emerged, changing the threshold value and repeating (b)-(d). In response to a detection that a data exclusion error has not emerged: a new set of data samples is generated by applying a variational autoencoder (VAE) to the clean fraction; the dirty dataset is augmented with the new set of data samples; and the augmented dirty dataset is provided for training of the ML model.

In certain example embodiments, a method for training a machine learning (ML) model is provided. In certain example embodiments, the method includes, (a) executing at least one error detector on a dirty dataset to identify which records of the dirty dataset include errors; (b) marking as erroneous each record that has been identified as including an error, based on a comparison to a threshold value; (c) dividing the records from the dirty dataset into a clean fraction and a dirty fraction, the dirty fraction including the record(s) marked as erroneous, the clean fraction including the record(s) not marked as erroneous; (d) detecting whether a data exclusion error emerges in the dividing of the records into the clean fraction and the dirty fraction; and (e) in response to a detection that a data exclusion error has emerged, changing the threshold value and repeating (b)-(d). In response to a detection that a data exclusion error has not emerged: a new set of data samples is generated by applying a variational autoencoder (VAE) to the clean fraction; the dirty dataset is augmented with the new set of data samples; and the augmented dirty dataset is provided for training of the ML model.

In certain example embodiments, there is provided a non-transitory computer readable storage medium tangibly storing instructions that, when executed by at least one processor of a system for training a machine learning (ML) model, perform the method of the prior paragraph.

In certain example embodiments, the features disclosed in the six following paragraphs can be used in connection with the above-summarized system, method, and/or non-transitory computer readable storage medium.

According to certain example embodiments, the at least one preprogrammed error detector may comprise a plurality of different preprogrammed error detectors. For instance, in certain example embodiments, each error detector may be unique compared to each other error detectors, e.g., in what types of errors it is configured to identify and/or in how it is preprogrammed to identify errors. For instance, a first one of the error detectors may be an ML-based error detector and a second one of the error detectors may be an ensemble error detector.

According to certain example embodiments, a voting system may be used when there are a plurality of different error detectors. In such instances, and for example, part (b) may include marking as erroneous each record that has been identified as including an error by a number of the error detectors that meets or exceeds the threshold value.

According to certain example embodiments, part (d) may include detecting class-level and attribute-level data exclusion errors. In this regard, in some instances, a class-level data exclusion error may be detected provided that there are more classes present in the dirty dataset compared to the clean fraction, and/or an attribute-level data exclusion error may be detected provided that there are no records in the clean fraction.

According to certain example embodiments, part (b) may be practiced by maintaining a list of indices of the records that have been identified as including errors.

According to certain example embodiments, each record newly added to the clean fraction upon a repetition of (b)-(d) triggered by (e) may be identified as a partially clean record; and each partially clean record may be modified prior to the generation of the new set of data samples. In this regard, in some instances, the modification of each partially clean record may include replacing at least some of the data in the respective partially clean record, e.g., with a statistical measure derived from within that data's corresponding class.

According to certain example embodiments, the VAE may include first and second feed-forward neural networks, e.g., with the first feed-forward neural network being an encoder and the second feed-forward neural network being a decoder.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a diagram showing a part of the machine learning (ML) preparation pipeline, where an error detection tool is used to identify errors in a noisy or dirty dataset;

FIG. 2 illustrates a record with a plurality of cells and one cell with a missing value, i.e., an empty cell;

FIG. 3 is a modified version of the pipeline of FIG. 1, where several data repair techniques are involved in the preparation process;

FIGS. 4A-4C are graphs that help to illustrate the approach underlying certain example embodiments;

FIG. 5 is a diagram showing a part of an ML preparation pipeline in accordance with certain example embodiments;

FIG. 6 is a block diagram showing a detailed architecture of certain example embodiments;

FIGS. 7A-7C show sampling problems related to poor error detection;

FIG. 8 is a flowchart showing the adaptive ensemble approach of certain example embodiments; and

FIG. 9 shows an example of tuning the hyperparameter K while detecting errors in a dataset, in accordance with certain example embodiments.

### DETAILED DESCRIPTION

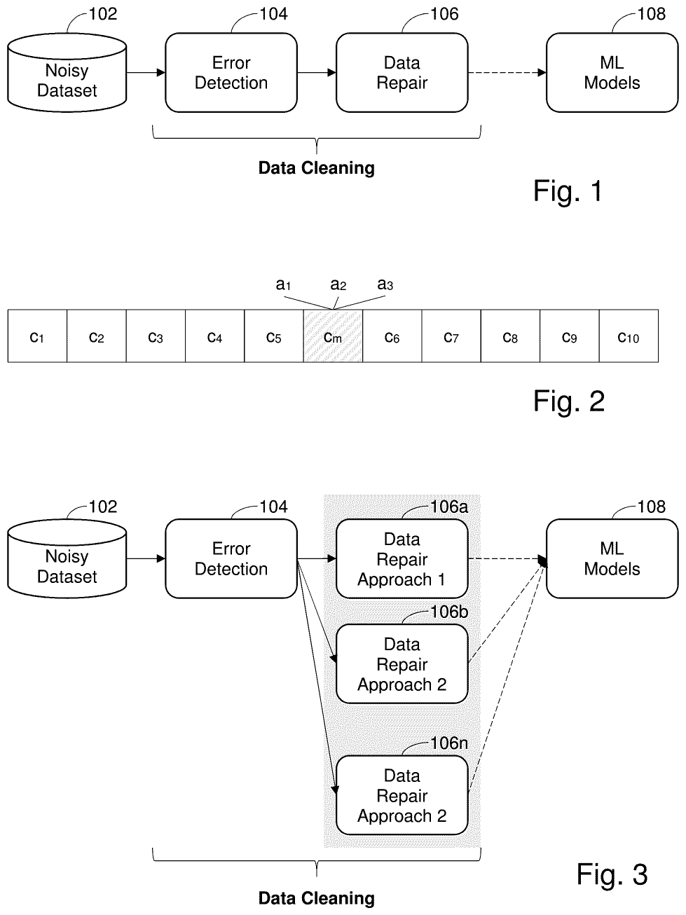

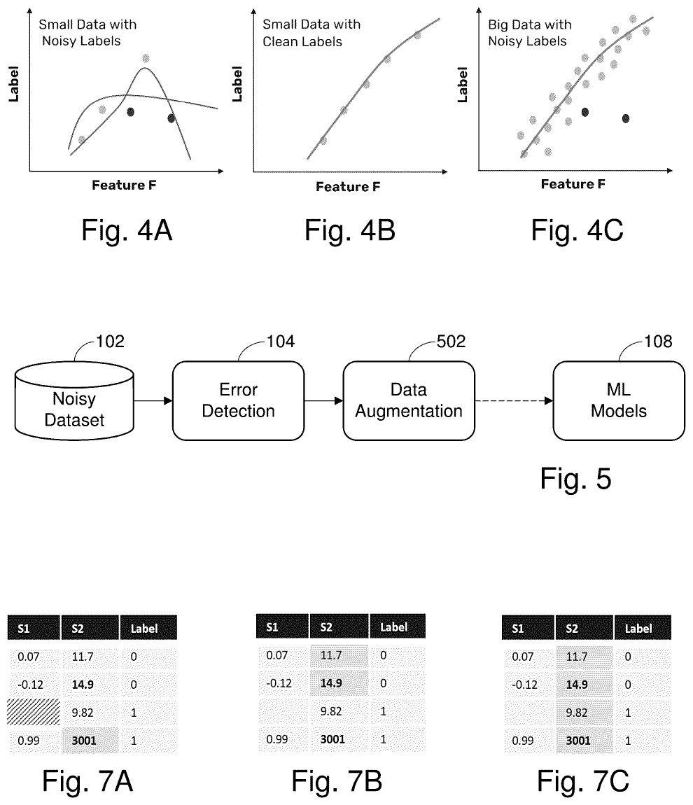

Certain example embodiments replace data repair techniques with data augmentation techniques to help mitigate the impact of noise in a noisy dataset used in producing machine learned (ML) models. It has been observed that training ML models on dense noisy data is broadly equivalent to training them on smaller sets of clean data. Moreover, increasing the amount of training data synthetically is a common way to improve ML model accuracy and to avoid overfitting, so the techniques of certain example embodiments can be incorporated into existing technology platforms. FIG. 5 is a diagram showing a part of an ML preparation pipeline in accordance with certain example embodiments. The FIG. 5 example may be thought of as being a modified version of the pipeline shown in FIG. 1. In FIG. 5, data augmentation 502 is introduced, and data repair is in essence “skipped.” It has been found that proper identification of the clean fraction of the dataset is an enabler of the technology disclosed herein. The clean fraction of a dataset is a subset of the original dirty dataset that includes clean or at least partially clean data samples. As explained in greater detail below, the clean fraction is used as an input to a variational autoencoder (VAE) module to augment the clean data samples and consequently reduce the impact of noisy data samples. Accordingly, certain example embodiments comprise three main phases, including (1) detecting different errors, (2) extracting the clean fraction including all classes, and (3) generating additional data from the same distribution.

FIG. 6 is a block diagram showing a detailed architecture of certain example embodiments. A dirty dataset 602 is prepared before being used to train one or more ML models 604. Therefore, the dirty dataset 602 is used as an input to an adaptive ensemble-based error detection module 606. In certain example embodiments, the input dataset may be from a relational or other database management system (DBMS), Internet-of-Things (IoT) devices, open data source, and/or the like. Backend tools that may make use of the data (and the model(s) 604) include, for example, TrendMiner, APAMA, Zementis, and Machine Learning Workbench (MLW), all of which are commercially available from the assignee. These tools are improved by virtue of having improved models trained on better data.

The adaptive ensemble-based error detection module 606 helps to maximize detection recall, which is the fraction of erroneous data samples that are detected. Moreover, by using the adaptive ensemble-based error detection module 606, sampling problems that might occur because of poor detection performance can be handled appropriately (e.g., as discussed in greater detail below in connection with false positive problems creating disadvantageous class- and attribute-related exclusions). The adaptive ensemble-based error detection module 606 implements a number of error detection techniques 608a-608n, such as a missing value (MV) detector 608a, an outlier detector 608b, a duplicates detector, a rule violation detector, an ML-based error detector 608n, etc. Each of these detectors generates a list of indices corresponding to the dirty samples detected by each method, e.g., D₁={C31}, D₂={C22, C42}. To combine all these detections, a voting mechanism 610 is implemented. The samples detected by at least K methods are annotated as being erroneous. In certain example embodiments, K may be a user-specified threshold, an adaptive threshold determined from a user-specified initial threshold, and/or the like.

After generating a list of erroneous data samples D₁∩D₂∩ . . . ∩Dₖ, an adaptive data sampler (ADS) 612 is used to divide the dataset S into two fractions, namely, a dirty fraction and a clean fraction 614. The ADS 612 monitors the clean version of the data to check whether relevant data exclusion problems emerge (e.g., as discussed in greater detail below). If a problem is detected, the ADS 612 modifies the value of the hyperparameter K so that the relevant data exclusion problems are resolved. The extracted clean fraction 614 of the data is then used as an input to a variational autoencoder (VAE) module to generate a new set of data from the same distribution.

A VAE is a neural network architecture that provides a probabilistic manner for describing a dataset in the latent space. It works with an encoder (sometimes referred to as the recognition model), a decoder (sometimes referred to as the generative model), and a loss function. The encoder and decoder are trained jointly such that the output minimizes reconstruction error and the KL divergence between the parametric posterior (i.e., distribution of the generated data) and the true posterior (i.e., distribution of the original data). The latent space representation refers to a compressed version of a dataset that can be obtained through passing the dataset through an encoder model (e.g., a feed-forward neural network), and KL (Kullback-Leibler) divergence is a statistical distance that measures how one probability distribution is different from a second (or reference) probability distribution. As explained in greater detail below, the VAE module is used for augmenting different data models, e.g., relational data, images, and/or the like. Although KL divergence is used in certain example embodiments, other difference measures (such as, for example, L1 or L2 loss) can be used in different instances.

As FIG. 6 shows, the VAE module implements two feed-forward neural networks, namely, an encoder 616 and a decoder 618. The encoder 616 learns the distribution of the latent space representation of the clean data (and potentially attributes thereof including, for example, the mean and standard deviation). Afterward, the decoder 618 uses a sampled latent vector 620 to generate data samples 622 similar to the inputs. In this context, the optimization problem is to minimize (1) the reconstruction loss function, which compares the inputs with the decoder-generated values, and (2) the KL divergence, which statistically differentiates between the probability distributions of the input and generated data. Data is aggregated 624, e.g., for use in training the ML models 604.

### Example Implementation

Details concerning an example implementation are provided below. It will be appreciated that this example implementation is provided to help demonstrate concepts of certain example embodiments, and aspects thereof are non-limiting in nature unless specifically claimed. For instance, the models, error types, detector types, measures, etc., are provided below to ease understanding of the example embodiments described herein and are not limiting unless explicitly claimed.

It will be appreciated that the detectors, modules, VAE (and its components), ADS, voting mechanism, and aggregator discussed herein, may be implemented as program logic executable by at least one processor of a computer system, e.g., as functions, routines, or code snippets that are executable. They may be provided in a distributed computing system such as, for example, a cloud computing environment. Some or all of these components may be local to or remote from the dirty dataset 602, the ML model(s) 604, computer-based tools that implement the ML model(s) 604, etc. The aggregated data may be used to train the ML model(s) 604 using ML-based training techniques using the same or different computing system.

### Example Adaptive Ensemble-Based Error Detection Related Techniques

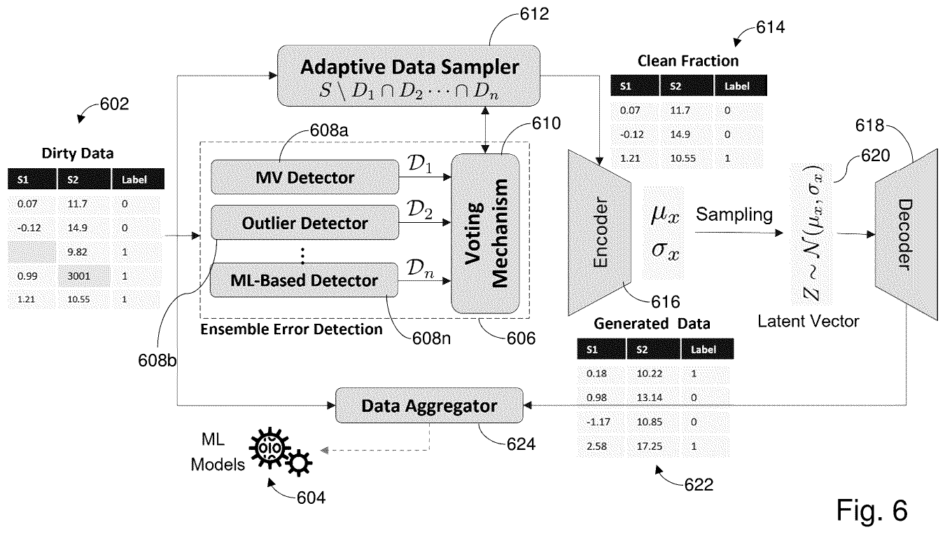

Before delving into the details of the adaptive ensemble-based error detection techniques of certain example embodiments, shortcomings of certain error-specific detection approaches will be discussed. In this regard, each error-specific detection approach typically tackles only a subset of the errors in the dataset, e.g., errors of a certain error type. For instance, a missing value detector is designed to find missing values while overlooking other errors. Similarly, outlier detectors usually employ statistical measures to differentiate between inliers and outliers while ignoring other error types such as rule violations and duplicates. FIGS. 7A-7C show sampling problems related to poor error detection. FIG. 7A, for instance, is an example of the low recall problem of error-specific detection methods. FIG. 7A shows a dirty dataset with two errors, including a missing value and an outlier. If an outlier detector has been used as the sole method for error detection, the highlighted value (3001) will be identified but the missing or null value (marked with hatching) will not be detected. In this case, a detection recall of 50% is achieved because of the missing/null value.

To help maximize detection recall, there are several techniques that can be categorized into two general groups, namely, ML-based techniques and ensemble techniques. The first category (ML-based techniques) comprises detection techniques that employ semi-supervised binary classifiers to differentiate between clean and dirty data samples. ML-based detection techniques typically achieve higher recall compared to error-specific techniques. The second category (ensemble techniques) comprises techniques that utilize several error-specific detection approaches. The detections obtained by such techniques are used as input to a voting mechanism. For instance, a data sample is annotated as dirty if it has been detected by at least K error-specific detection methods. To address low detection recall of error-specific error detectors, the value of the hyperparameter K can be fixed for all records in the dirty dataset. This strategy simplifies the implementation of the ensemble detection approach.

The ensemble detection technique has been observed to improve detection recall while also providing a “knob” permitting at least some control over the detection precision (defined as the fraction of relevant instances, e.g., actual dirty data samples, among the detected samples). That is, adjustment of the hyperparameter K can affect detection precision. However, both ML-based and ensemble detection techniques may suffer from several problems, especially when they are used specifically to extract a clean subset from the dirty data, as is done in certain example embodiments. For instance, in an ensemble-based error detection technique, fixing the value of the hyperparameter K may prevent the detection method from dynamically reacting to possible data exclusion problems.

To illustrate potential problems with data exclusion, FIGS. 7B-7C depicts two examples, including class-level and attribute-level data exclusion problems that might occur because of false positives caused by some error-specific detection approaches. FIG. 7B represents a dirty dataset, where the ensemble approach annotated the shaded cells as dirty. Consequently, the records corresponding to these dirty cells will not be included in the clean fraction, which will be used as an input to the VAE-based data augmentation module described in greater detail below. In this case, the clean fraction will not include any records that correspond to the class “0”. Accordingly, the data augmentation module will generate data whose label is “1” only. This may negatively affect the training data ultimately produced, because an entire class of data from the source will be excluded. To sum up, then, a class-level data exclusion problem occurs when all records of a certain class have been detected as erroneous. And in this case, that class will be entirely excluded in the clean fraction and the generated data, with potential adverse effects on the training data.

In contrast with a class-level data exclusion problem, an attribute-level data exclusion problem occurs when all entries of a certain attribute have been detected as being erroneous. Accordingly, no clean fraction can be extracted. FIG. 7C depicts an example of such a situation where the entries of the attribute S2 have been annotated by the ensemble approach as being erroneous. Therefore, the data sampler employed in certain example embodiments will consider all records in this dataset as dirty and the clean fraction will be empty unless other actions are taken (such as, for example, those described in greater detail below).

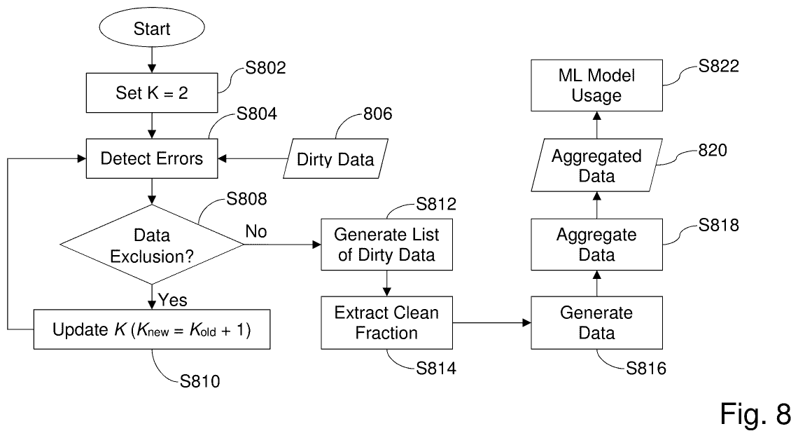

To enable the ensemble-based error detection approach of certain example embodiments to overcome the above-described problems, a novel adaptive ensemble approach is implemented. The adaptive ensemble approach of certain example embodiments can seamlessly interact with the data sampler, as shown in FIG. 6. The adaptive approach of certain example embodiments seeks to include all classes in the extracted clean fraction. This is performed by making the detection decision iteratively. In other words, the data sampler adjusts the value of the hyperparameter K whenever it detects the occurrence of data exclusion problems. This approach is set forth in greater detail in FIG. 8.

In this regard, FIG. 8 is a flowchart showing the adaptive ensemble approach of certain example embodiments. An inventory of several error-specific and ML-based error detection techniques is implemented. This inventory may include, for example, KATARA, NADEEF, HoloClean, OpenRefine, dBoost, FAHES, Isolation Forest, ZeroER, metadata-driven, ED2, RAHA, and/or other error detectors, for example. In step S802, the value of the hyperparameter K is set to a small value that is larger than one (e.g., set K=2, as setting K=1 implies using only one error-specific or ML-based detection technique). In step S804, dirty cells in the dirty data 806 are detected using the approaches in the detection inventory.

Once the detections are generated by each approach, a min-K voting mechanism is applied to decide upon the final detection decision. MM-K voting is a mechanism for making the final decision regarding several competing entities. For instance, in certain example embodiments, several error detection methods annotate each data sample as either erroneous or clean, and the min-K mechanism annotates each sample as erroneous if it has been detected by at least K detection methods. Subsequently, a single list of indices, corresponding to the erroneous samples, is generated. This list is used by the ADS to extract the clean data fraction. However, the ADS first checks for the occurrence of class-level or attribute-level relevant data exclusion problems in step S808. The ADS compares the number of classes in the dirty data and in the clean fraction to detect whether there is a class-level data exclusion problem. For example, if the number of classes in the dirty data is greater than the number of classes in the clean fraction, then a determination is made that there is a class-level data exclusion problem. Attribute-level data problems are detected if the size of the clean fraction is equal zero.

If either of these problems occurs (i.e., if either or both of a class-level or attribute-level relevant data exclusion problem is detected), the ADS in step S810 adjusts the value of the hyperparameter K to try to sidestep the encountered problem(s). Specifically, it increases the value of K and repeats the detection process by looping back to step S804 with the increased K value. The ADS keeps checking for the occurrence of data exclusion problems and adjusting the hyperparameter K until all data exclusion problems are resolved (or at least none are detected in an iteration of step S808). In a sense, the value of K is adjusted during runtime based on how well the error detection is performing. Although mM-K voting has been discussed above, other voting approaches (such as, for example, ranked voting and majority voting) can be used in different example embodiments. Some voting approaches may, for example, different weight the outputs from different error detectors. For example, if a particular error detector is known or expected to perform particularly well based on the content of dataset or other contextual factors (e.g., based on a user's domain experience, prior runs, etc.), a vote from such an error detector may be more heavily weighted. This may matter in voting schemes where, for example, the records having more than A votes or more than B % of votes are identified, all records having more than a predetermined number of votes are identified as erroneous, etc.

The ADS identifies the dirty data in step S812 (based on the voting approach) and in step S814 extracts from the dirty dataset a list of clean data to be used for data augmentation. It will be appreciated that increasing the value of the hyperparameter K may lead to the extraction of partially clean data samples. These samples are the ones whose detection decisions have been changed after the hyperparameter tuning process. A list of these partially clean data may be maintained, and the partially clean data in this list may be flagged for follow-up processing. For example, such partially clean samples may be replaced with statistical measures within their corresponding class, e.g., median, mean, or mode. This approach may partially or completely replace the particular partially clean record. For instance, only the data determined to have an error may be replaced. In certain example embodiments, an attempt to repair the partially clean record may be made (e.g., using a known repair approach). If that repair cannot be performed, then the partially clean record can be replaced. It will be appreciated that different statistical measures have different advantages and disadvantages, e.g., depending on the data. For example, where there is a broad variance, the mean or mode may not be very descriptive. Similarly, a median value may not be very descriptive when the data distribution is highly skewed. Thus, different statistical measures can be used in different implementations. A user with domain expertise, for example, may set the particular measure to be used in different example embodiments.

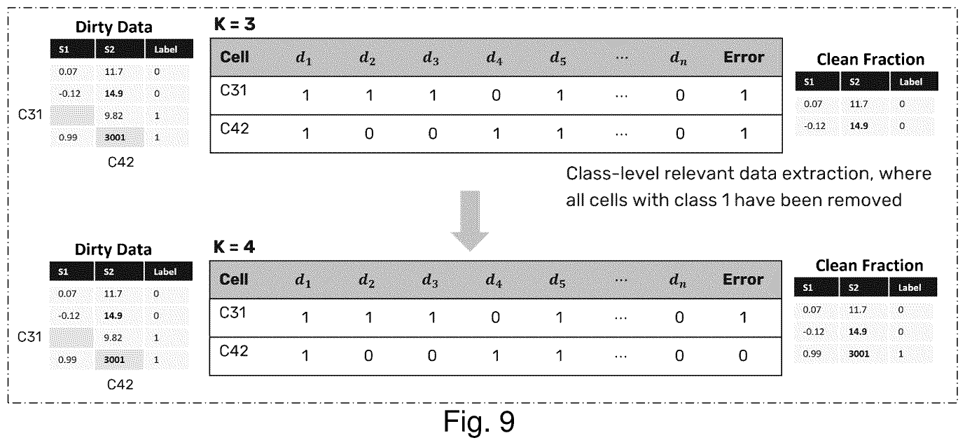

FIG. 9 shows an example of tuning the hyperparameter K while detecting errors in a dataset, in accordance with certain example embodiments. In other words, FIG. 9 provides an example of adapting the ensemble error detection approach in accordance with certain example embodiments. The top part of FIG. 9 shows the situation before the hyperparameter tuning process, where K=3. In this example, the cell C31 has been detected by four detection methods, i.e., d₁, d₂, d₃, and d₅, while the cell C42 has been detected by three detection methods, i.e., d₁, d₄, and d₅. According to the min-K vote mechanism, both cells will be annotated as erroneous since they have been detected by at least three methods. Consequently, these cells will be excluded from the clean fraction, as shown on the top right table. In this case, a class-level data exclusion problem occurs, where the clean fraction lacks records with the class “1”. To resolve this problem, the ADS increases the hyperparameter K from three to four. In this case, the cell C42 does not exceed the threshold. Accordingly, it is annotated as a (partially) clean data sample and thus is included in the clean fraction. In certain example embodiments, the partially clean data samples are replaced with the mean value of its attribute (although other replacement approaches can be used as noted above).

Referring once again to FIG. 8, after extracting a clean fraction of the data (as in step S14), a data augmentation module is used to generate similar data in step S816. Here, it is advantageous to generate data having the same distribution as the clean fraction. The assignee examined three data augmentation approaches dedicated to tabular data, including MODALS, Variational Autoencoders (VAEs), and Conditional Tabular Generative Adversarial Network (CTGAN). It was found that VAE-based augmentation outperformed the other approaches. Specifically, the assignee examined these three methods in an ML pipeline where the VAE data augmentation achieved predictive accuracy of above 0.98 for several datasets. Therefore, certain example embodiments may implement a VAE-based approach (although different example embodiments may use other techniques). Finally, the newly generated data is combined with the original data in step S818 to generate aggregated data 820 (which in essence increase the overall density of the data), before being used for training data, modeling, and serving various ML models as in step S822.

### Example Variational Autoencoder Related Techniques

In general, autoencoders implement two components, namely an encoder and a decoder. The encoder compresses the input dataset in low dimensional space, referred to as the latent space representation. Afterward, the decoder exploits the latent space representation to recover the input dataset. For this purpose, autoencoders typically have a loss function to compare the original data with values generated by the decoder. Autoencoders can be useful tools for data augmentation by performing some variations in the latent space. To this end, the VAE module trains its encoder to extract the parameters of the data distributions rather than the latent space representation. As depicted in FIG. 6, the decoder generates a two-dimensional vector including the mean μₓ and the variance σₓ. Afterward, multiple data samples are generated from (for example) the Gaussian distribution N(μₓ, σₓ) formed using the extracted parameters. Such data samples are then used as an input to the decoder to generate similar data.

In addition to the reconstruction loss, the VAE module employs the KL divergence to distinguish between the probability distributions of the original dataset (i.e., clean fraction) and the generated data. As noted above, the KL divergence is a statistical measure that quantifies how a probability distribution differs from a reference distribution. The VAE module strives to reduce the value of KL divergence via optimizing the mean and variance to simulate the input distribution. It is noted that the clean fraction is preprocessed before forwarding it to the VAE module. In this regard, the clean fraction is split into two sets (train and test sets). Train and test sets are used to get train and test losses in each epoch. Such losses are used to guide the weight adjustment process in such a way to reduce the losses. Second, feature transformation is performed to standardize the training and testing sets. Standardization in certain example embodiments involves transforming the numerical data to be in the range between 0 and 1. A standard scaler may be used for this purpose, e.g., to standardize the numerical data by subtracting the mean and dividing by the standard deviation. Because the clean fraction is passed in tensors, the DataLoaders from a Torch package can be used to prepare the dataset and give it to the model. As is known, Torch is a (among other things) an open-source machine-learning library. In order to use Torch packages, the data may be stored in a specific data structure, called a Tensor. For this purpose, the DataLoader method may be used to convert the input data into Tensors. Such Tensors then can be used by methods in the Torch package.

The VAE module of certain example embodiments includes an encoder, a decoder, and a reparameterizer. Both the encoder and the decoder can be implemented as feed-forward neural networks. The inputs to the VAE module are the train set, the test set, the dimensions of the clean fraction, the number of nodes in the hidden layers, and the number of latent factors. Each hidden layer includes a set of artificial neurons (nodes) that take in a set of weighted inputs and produce an output through an activation function. The number of nodes in the input layer of the encoder and in the output layer of the decoder has been set to the number of attributes in the clean fraction. The encoder and decoder comprise two hidden layers, and the number of nodes in the first and second hidden layers has been set to 50 and 12, respectively. The nodes perform non-linear transformations of the inputs entered into the neural network. The inventor performed an analysis with different configurations and found that these numbers achieve the best performance for different datasets in certain example instances. It will be appreciated, however, that the number of nodes depends highly on the application. Thus, different example embodiments may use different numbers. The Adam optimizer was employed to optimize the parameters and custom loss, which is combined mean square error and KL divergence. In general, optimizers are algorithms used to change the attributes of the neural network such as weights and learning rate to reduce the losses. Alternatives to Adam optimizers that could be used in certain example embodiments include Stochastic gradient descent (SGD), SGD with momentum, Nesterov Accelerated Gradient (NAG), Adaptive Gradient (AdaGrad), etc. Thus, it will be appreciated that the technology disclosed herein is not limited to Adam optimizers. The ReLu activation function was added for each layer in the encoder and decoder. The ReLu function provides the nonlinear transformation of the data, and it was used rather than over other activation functions because it is fast and straightforward to compute and helps overcome the challenge of vanishing gradients. It will be appreciated that different activation functions can be used in different example embodiments.

As explained above, the decoder samples data from the latent space randomly. This approach to sampling data from a distribution that is parameterized by the model that the VAE uses (the encoder module) is not differentiable. Backpropagation is used to train neural networks in certain example embodiments, e.g., by adjusting the model's weights and using gradient descent (e.g., it calculates the gradient (derivatives) of the loss function at output, and distributes it back through the layers of a neural network). To this end, both the activation function and the loss function should be differentiable. In general, a differentiable function is simply a function whose derivative exists at each point. In this case, it can be relatively challenging to perform backpropagation (useful in optimizing the weights of the encoder and the decoder) over the random node Z. To overcome this problem, the reparameterization process is performed to enable backpropagation through the random node. To this end, the reparameterizer component turns the random node Z˜N(μₓ, σₓ) into a differentiable function Z=μ+σ⊙ε, where ε˜N(0,1) represents the standard Gaussian distribution and it is irrelevant for taking the gradients (which is a step in a typical backpropagation process).

The latent factors are the compressed forms of clean fraction, represented as two vectors of the distribution parameters (μ=μ₁, . . . , μₙ and σ=σ₁, . . . , σₙ). During the training of the VAE, different distributions are learned based on the number of latent factors. In other words, the learned parameters are simply the mean and variance of each latent factor. Each learned normal distribution is used to create new data samples using its mean and variance. Afterwards, these generated samples from the latent factors are used as an input to the encoder to generate similar data of a given size. Subsequently, a scaler is used to transform the generated data to the original form of the clean fraction. While preparing the data, a standard scaler is used to standardize the data. After generating the new data, the same standard scaler is used to convert the standardized values back to their original form (e.g., by adding the mean and multiplying by the standard deviation). Finally, the augmented data is combined with the original dirty dataset, before being stored in a CSV or other file.

The techniques of certain example embodiments were analyzed with several datasets and several machine learning models, e.g., multi-layer perception (MLP), random forest, and XGBoost. The results showed that the techniques disclosed herein greatly improves the predictive performance. For instance, the techniques disclosed herein increased the accuracy of the MLP classifier, trained on the smart factory dataset, from 66% using the dirty dataset to 84.3%. Thus, certain example embodiments improve ML-based modeling tools greatly, allowing them to deliver much more accurate predictions and in turn enabling better recommendations to be generated.

Although certain example embodiments have been described as making use of the min-K voting procedure, different example embodiments may use different voting approaches. Similarly, although certain example embodiments produce additional samples using a Gaussian distribution based on mean and standard deviation values (e.g., because data oftentimes has a normal distribution), different example embodiments may generate additional samples using other distributions and/or different measures. For example, depending on the dataset, a non-normal distribution may be appropriate and, in such cases, exponential, binomial, Poisson, logarithmic, and/or other distributions may be appropriate. In certain example embodiments, the distribution to be used can be specified by a user.

Although VAEs were determined to provide the best F1 values (which measure recall and precision of a model) of the tested alternatives, it will be appreciated that other data augmentation approaches may be used in different example embodiments.

Although certain example embodiments have been described as skipping data repair techniques, it will be appreciated that the technology disclosed herein can be used in connection with one or more different data repair techniques, e.g., as a precursor to the data augmentation techniques disclosed herein.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for training a machine learning (ML) model, comprising:
at least one preprogrammed error detector;
at least one processor and a memory coupled thereto, the at least one processor being configured to perform operations comprising:
(a) executing the at least one error detector on a dirty dataset to identify which records of the dirty dataset include errors;
(b) marking as erroneous each record that has been identified as including an error, based on a comparison to a threshold value;
(c) dividing the records from the dirty dataset into a clean fraction and a dirty fraction, the dirty fraction including the record(s) marked as erroneous, the clean fraction including the record(s) not marked as erroneous;
(d) detecting whether a data exclusion error emerges in the dividing of the records into the clean fraction and the dirty fraction;
(e) in response to a detection that a data exclusion error has emerged, changing the threshold value and repeating (b)-(d); and
(f) in response to a detection that a data exclusion error has not emerged:
generating a new set of data samples by applying a variational autoencoder (VAE) to the clean fraction;
augmenting the dirty dataset with the new set of data samples; and
providing the augmented dirty dataset for training of the ML model.

2. The system of claim 1, wherein the at least one preprogrammed error detector comprises a plurality of different preprogrammed error detectors.

3. The system of claim 2, wherein each error detector is unique compared to each other error detectors in what types of errors it is configured to identify and/or in how it is preprogrammed to identify errors.

4. The system of claim 2, wherein a first one of the error detectors is an ML-based error detector and a second one of the error detectors is an ensemble error detector.

5. The system of claim 2, wherein (b) includes marking as erroneous each record that has been identified as including an error by a number of the error detectors that meets or exceeds the threshold value.

6. The system of claim 1, wherein (d) includes detecting class-level and attribute-level data exclusion errors.

7. The system of claim 6, wherein a class-level data exclusion error is detected provided that there are more classes present in the dirty dataset compared to the clean fraction, and wherein an attribute-level data exclusion error is detected provided that there are no records in the clean fraction.

8. The system of claim 1, wherein (b) is practiced by maintaining a list of indices of the records that have been identified as including errors.

9. The system of claim 1, wherein the at least one processor is configured to perform further operations comprising:
identifying as a partially clean record each record newly added to the clean fraction upon a repetition of (b)-(d) triggered by (e); and
modifying each partially clean record prior to the generation of the new set of data samples.

10. The system of claim 9, wherein the modification of each partially clean record includes replacing at least some of the data in the respective partially clean record with a statistical measure derived from within that data's corresponding class.

11. The system of claim 1, wherein the VAE includes first and second feed-forward neural networks, the first feed-forward neural network being an encoder and the second feed-forward neural network being a decoder.

12. A method for training a machine learning (ML) model, the method comprising:
(a) executing at least one error detector on a dirty dataset to identify which records of the dirty dataset include errors;
(b) marking as erroneous each record that has been identified as including an error, based on a comparison to a threshold value;
(c) dividing the records from the dirty dataset into a clean fraction and a dirty fraction, the dirty fraction including the record(s) marked as erroneous, the clean fraction including the record(s) not marked as erroneous;
(d) detecting whether a data exclusion error emerges in the dividing of the records into the clean fraction and the dirty fraction;
(e) in response to a detection that a data exclusion error has emerged, changing the threshold value and repeating (b)-(d); and
(f) in response to a detection that a data exclusion error has not emerged:
generating a new set of data samples by applying a variational autoencoder (VAE) to the clean fraction;
augmenting the dirty dataset with the new set of data samples; and
providing the augmented dirty dataset for training of the ML model.

13. The method of claim 12, wherein the at least one preprogrammed error detector comprises a plurality of different preprogrammed error detectors.

14. The method of claim 13, wherein each error detector is unique compared to each other error detectors in what types of errors it is configured to identify and/or in how it is preprogrammed to identify errors.

15. The method of claim 13, wherein a first one of the error detectors is an ML-based error detector and a second one of the error detectors is an ensemble error detector.

16. The method of claim 13, wherein (b) includes marking as erroneous each record that has been identified as including an error by a number of the error detectors that meets or exceeds the threshold value.

17. The method of claim 12, wherein (d) includes detecting class-level and attribute-level data exclusion errors,
wherein a class-level data exclusion error is detected provided that there are more classes present in the dirty dataset compared to the clean fraction, and wherein an attribute-level data exclusion error is detected provided that there are no records in the clean fraction.

18. The method of claim 12, further comprising:
identifying as a partially clean record each record newly added to the clean fraction upon a repetition of (b)-(d) triggered by (e); and
modifying each partially clean record prior to the generation of the new set of data samples.

19. The method of claim 12, wherein the VAE includes first and second feed-forward neural networks, the first feed-forward neural network being an encoder and the second feed-forward neural network being a decoder.

20. A non-transitory computer readable storage medium tangibly storing instructions that, when executed by at least one processor of a system for training a machine learning (ML) model, perform operations comprising:
(a) executing at least one error detector on a dirty dataset to identify which records of the dirty dataset include errors;
(b) marking as erroneous each record that has been identified as including an error, based on a comparison to a threshold value;
(c) dividing the records from the dirty dataset into a clean fraction and a dirty fraction, the dirty fraction including the record(s) marked as erroneous, the clean fraction including the record(s) not marked as erroneous;
(d) detecting whether a data exclusion error emerges in the dividing of the records into the clean fraction and the dirty fraction;
(e) in response to a detection that a data exclusion error has emerged, changing the threshold value and repeating (b)-(d); and
(f) in response to a detection that a data exclusion error has not emerged:
generating a new set of data samples by applying a variational autoencoder (VAE) to the clean fraction;
augmenting the dirty dataset with the new set of data samples; and
providing the augmented dirty dataset for training of the ML model.
